(19) United States
(12) Patent Application Publication
(10) Pub. No.: US 2016/0260125 A1
(43) Pub. Date: Sep. 8, 2016

(54) Systems and Methods for Cold-start and Continuous-learning via Evolutionary Explorations

(71) Applicant: YAHOO! INC., Sunnyvale, CA (US)

(72) Inventors: Jian XU, San Jose, CA (US); Zhonghao LU, Beijing (CN)

(73) Assignee: YAHOO! INC., Sunnyvale, CA (US)

(21) Appl. No.: 14/640,661

(22) Filed: Mar. 6, 2015

(51) Int. Cl. G06Q 30/02

(52) U.S. Cl. CPC G06Q 30/0246

(57) ABSTRACT

Systems and methods for cold-start and continuous-learning via evolutionary explorations are provided. The system includes a database including serving data. A computer server is in communication with the database, the computer server is programmed to: obtain an advertisement opportunity including user data and page data; extract semantic features from the user data, the page data, and a campaign; determine a score that measures a similarity between the advertisement opportunity and the campaign using the semantic features; assign a set of weights to the semantic features when determining the score during a first time period; collect click data on the campaign while using the set of weights to run the campaign in the first time period; update the set of weights using the click data by minimizing a logistic loss function; and assign an updated set of weights to the semantic features during a second time period.

### BACKGROUND

The Internet is a ubiquitous medium of communication in most parts of the world. The emergence of the Internet has opened a new forum for the creation and placement of advertisements (ads) promoting products, services, and brands. Internet content providers rely on advertising revenue to drive the production of free or low cost content. Advertisers, in turn, increasingly view Internet content portals and online publications as a critically important medium for the placement of advertisements.

In a demand-side platform (DSP) such as Yahoo Ad Manager Plus (YAM+), bidder is the key component which decides whether and at what price to bid for an ad opportunity (a.k.a. bid request) on behalf of an ad campaign. Most of the advertisers may seek to deliver impressions to an extensive audience and meanwhile achieve high campaign performance in terms of click-through-rate (CTR), action-rate (AR), or effective-cost-per-click (eCPC), effective-cost-per-action (eCPA), etc. Therefore, the advertisement system needs a good response (e.g. click, action) prediction model to meet the advertisers' expectations.

There are two interesting and correlated problems in deriving good response prediction models: cold-start and continuous-learning. Cold-start refers to identifying an initial set of ad opportunities to bid. Continuous-learning is to identify promising areas that deserve exploration after observing impressions and responses in learned areas. The existing online advertisement systems are not efficient and treat the two problems separately. Thus, there is a need to develop methods and systems with better response prediction models to help advertisers to identify more effective ad opportunities.

### SUMMARY

Different from conventional solutions, the disclosed system solves the above problem by using evolutionary explorations.

In a first aspect, the embodiments disclose a computer system that includes a processor and a non-transitory storage medium accessible to the processor. The system also includes a memory storing a database which includes serving data and campaign data. A computer server is in communication with the memory and the database. The computer server is programmed to obtain an advertisement opportunity including user data and page data, extract semantic features from the user data, the page data, and a campaign, and to determine a score that measures a similarity between the advertisement opportunity and the campaign using the semantic features. The computer is further programmed to assign a set of weights to the semantic features when determining the score during a first time period, collect click data on the campaign while using the set of weights to run the campaign in the first time period, update the set of weights using the click data by minimizing a logistic loss function, and to assign an updated set of weights to the semantic features during a second time period.

In a second aspect, the embodiments disclose a computer implemented method by a system that includes one or more devices having a processor. In the computer implemented method, the system obtains an existing campaign. The system extracts semantic features from the existing campaign and a new campaign. The system obtains a semantic similarity between the existing campaign and the new campaign using the semantic features. The system determines a score that combines the semantic similarity and a click through rate (CTR) of the existing campaign. The system selects an initial set of opportunities at least partially based on the score to cold-start the new campaign.

In a third aspect, the embodiments disclose a non-transitory storage medium configured to store a set of modules. The non-transitory storage medium includes a module for obtaining a performance-lift vector for an audience segment, where the performance-lift vector includes a difference of a performance of the audience segment for a campaign and an average performance of other audience segments for the campaign. The non-transitory storage medium further includes a module for obtaining a campaign vector using meta-data from a database comprising campaign data. The non-transitory storage medium further includes a module for obtaining a keyword vector for the audience segment using the performance-lift vector and the campaign vector. The non-transitory storage medium further includes a module for displaying a user interface and receiving an input from the user interface accessible to an advertiser. The non-transitory storage medium further includes a module for searching a database including segment data at least partially based on an input and the keyword vector for segments in the segment data.

### BRIEF DESCRIPTION OF THE DRAWINGS

FIG. 1 is a block diagram of an example environment in which a computer system according to embodiments of the disclosure may operate;

FIG. 2 illustrates an example computing device in the computer system;

FIG. 3 illustrates an example embodiment of a server computer for building a keyword index for an audience segment;

FIG. 4A is an example block diagram illustrating embodiments of the non-transitory storage of the server computer;

FIG. 4B is an example block diagram illustrating embodiments of the non-transitory storage of the server computer;

FIG. 5A is an example flow diagram illustrating embodiments of the disclosure;

FIG. 5B is an example flow diagram illustrating embodiments of the disclosure;

FIG. 6 is an example block diagram illustrating embodiments of the disclosure;

FIG. 7A is an example flow diagram illustrating embodiments of the disclosure;

FIG. 7B is an example flow diagram illustrating embodiments of the disclosure; and

FIG. 8 is an example block diagram illustrating embodiments of the disclosure.

### DETAILED DESCRIPTION OF THE DRAWINGS

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The term “social network” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like.

A social network may include individuals with similar experiences, opinions, education levels or backgrounds. Subgroups may exist or be created according to user profiles of individuals, for example, in which a subgroup member may belong to multiple subgroups. An individual may also have multiple “1:few” associations within a social network, such as for family, college classmates, or co-workers.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so-called ‘virtual persons.’ An individual's social network may be represented in a variety of forms, such as visually, electronically or functionally. For example, a “social graph” or “socio-gram” may represent an entity in a social network as a node and a relationship as an edge or a link.

While the publisher and social networks collect more and more user data through different types of e-commerce applications, news applications, games, social networks applications, and other mobile applications on different mobile devices, a user may by tagged with different features accordingly. Using these different tagged features, online advertising providers may create more and more audience segments to meet the different targeting goals of different advertisers. Thus, it is desirable for advertisers to directly select the audience segments with the best performances using keywords. Further, it would be desirable to the online advertising providers to provide more efficient services to the advertisers so that the advertisers can select the audience segments without reading through the different features or descriptions of the audience segments. The present disclosure provides a computer system that uses keyword vectors to represent an audience segment and provides intuitive user interfaces to allow advertisers to use keywords to search for any audience segments.

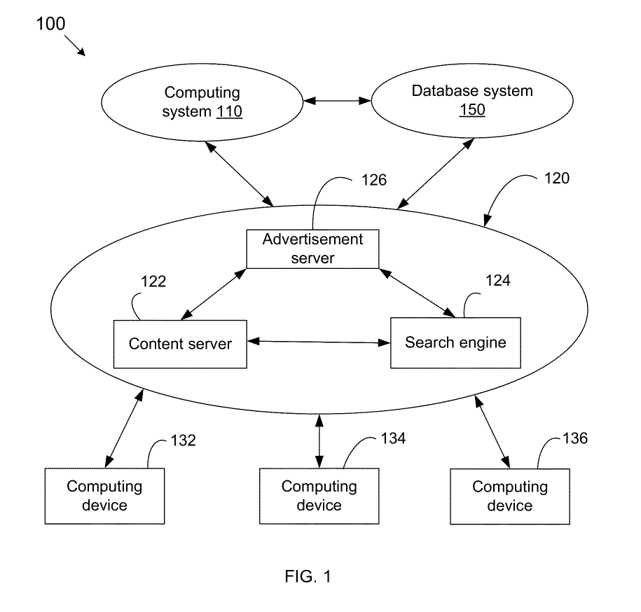

FIG. 1 is a block diagram of an environment 100 in which a computer system according to embodiments of the disclosure may operate. However, it should be appreciated that the systems and methods described below are not limited to use with the particular exemplary environment 100 shown in FIG. 1 but may be extended to a wide variety of implementations.

The environment 100 may include a computing system 110 and a connected server system 120 including a content server 122, a search engine 124, and an advertisement server 126. The computing system 110 may include a cloud computing environment or other computer servers. The server system 120 may include additional servers for additional computing or service purposes. For example, the server system 120 may include servers for social networks, online shopping sites, and any other online services.

The computing system 110 may include multiple processing systems and computers. One example is a backend computer server. The backend computer server is in communication with the database system 150.

The content server 122 may be a computer, a server, or any other computing device known in the art, or the content server 122 may be a computer program, instructions, and/or software code stored on a computer-readable storage medium that runs on a processor of a single server, a plurality of servers, or any other type of computing device known in the art. The content server 122 delivers content, such as a web page, using the Hypertext Transfer Protocol and/or other protocols. The content server 122 may also be a virtual machine running a program that delivers content.

The search engine 124 may be a computer system, one or more servers, or any other computing device known in the art, or the search engine 124 may be a computer program, instructions, and/or software code stored on a computer-readable storage medium that runs on a processor of a single server, a plurality of servers, or any other type of computing device known in the art. The search engine 124 is designed to help users find information located on the Internet or an intranet.

The advertisement server 126 may be a computer system, one or more computer servers, or any other computing device known in the art, or the advertisement server 126 may be a computer program, instructions and/or software code stored on a computer-readable storage medium that runs on a processor of a single server, a plurality of servers, or any other type of computing device known in the art. The advertisement server 126 is designed to provide digital ads to a web user based on display conditions requested by the advertiser. The advertisement server 126 may include computer servers for providing ads to different platforms and websites.

The computing system 110 and the connected server system 120 have access to a database system 150. The database system 150 may include memory such as disk memory or semiconductor memory to implement one or more databases. At least one of the databases in the database system may be a user database that stores information related to a plurality of users. The user database may be organized on a user-by-user basis such that each user has a unique record file. The record file may include all information related to a specific user from all data sources. For example, the record file may include personal information of the user, search histories of the user from the search engine 124, web browsing histories of the user from the content server 122, or any other information the user agreed to share with a service provider that is affiliated with the computer server system 120.

The environment 100 may further include a plurality of computing devices 132, 134, and 136. The respective computing devices may be implemented as a computer, a smart phone, a personal digital aid, a digital reader, a Global Positioning System (GPS) receiver, or any other device that may be used to access the Internet.

The disclosed system and method for cold-start and continuous-learning via evolutionary explorations may be implemented by the computing system 110. Alternatively or additionally, the system and method for cold-start and continuous-learning via evolutionary explorations may be implemented by one or more of the servers in the server system 120. The disclosed system may instruct the computing devices 132, 134, and 136 to display all or part of the user interfaces to request input from the advertisers. The disclosed system may also instruct the computing devices 132, 134, and 136 to display all or part of the brand performance to the advertisers.

Generally, an advertiser or any other user may use a computing device such as computing devices 132, 134, and 136 to access information on the server system 120 and the data in the database 150.

The advertiser may want to identify a target audience for the advertiser's product or services. Based on the target audience and the products, the advertiser may start one or more online advertising campaigns on different online platforms. One of the technical problems solved by the disclosure is a lack of efficiency in setting up an online advertising campaign. Conventional campaign setup requires substantial computer resources and time for locating and selecting desired audience segments. The disclosed solution increases the efficiency of online campaign setup so that an advertiser can use intuitive keywords to search all audience segments and identify the desired audience segments in real time.

Further, the system solves technical problems presented by managing large amounts of user data represented by different user features collected by all types of mobile applications. Through processing collected data, the systems index audience segments by keywords, so that the audience segments are searchable by keywords. The keyword index is indicative of the performance of the underlying audience segment. The keyword index has both semantic and performance meanings. Use of the keyword index provides a rapid and clear understanding of the expected performance for an audience segment. The keyword index may be tracked and understood by the advertisers or machines accessible to the advertisers.

The system further enables the data providers to save their efforts to name, document, train, or tag their segments in order to let each advertiser to be aware what the segment is for. With the keyword index, a data provider can easily quantify an audience segment using a keyword vector.

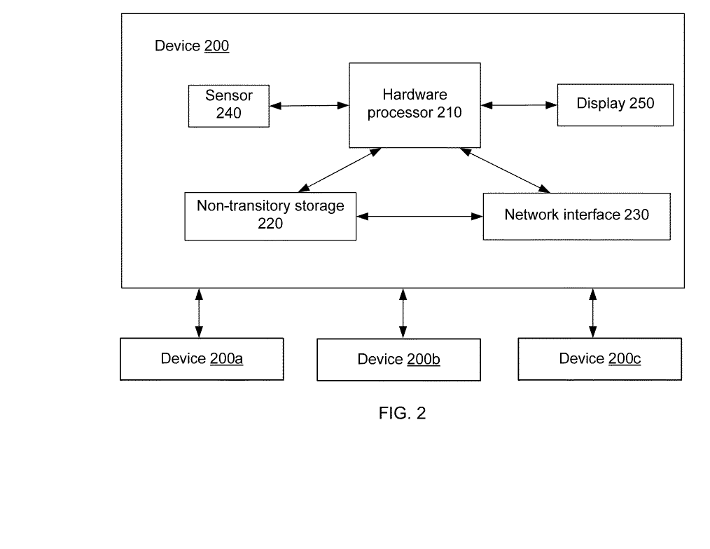

FIG. 2 illustrates an example computing device 200 for interacting with the advertiser. The computing device 200 may communicate with a frontend computer server of the computing system 100 of FIG. 1. The computing device 200 may be a computer, a smartphone, a server, a terminal device, or any other computing device including a hardware processor 210, a non-transitory storage medium 220, and a network interface 230. The hardware processor 210 accesses the programs and data stored in the non-transitory storage medium 220. The device 200 may further include at least one sensor 240, circuits, and other electronic components. The device may communicate with other devices 200a, 200b, and 200c via the network interface 230.

The computing device 200 may display user interfaces on a display unit 250. For example, the computing device 200 may display a user interface on the display unit 250 asking the advertiser to input one or more keywords. The user interface may provide checkboxes, dropdown selections or other types of graphical user interfaces for the advertiser to select geographical information, demographical information, mobile application information, technology information, publisher information, or other information related to features of an audience segment.

The computing device 200 may further display the predicted performance using one or more audience segments. The computing device 200 may also display one or more drawings or figures that have different formats such as bar charts, pie charts, trend lines, area charts, etc. The drawings and figures may represent the audience segments and/or the performance of the audience segments.

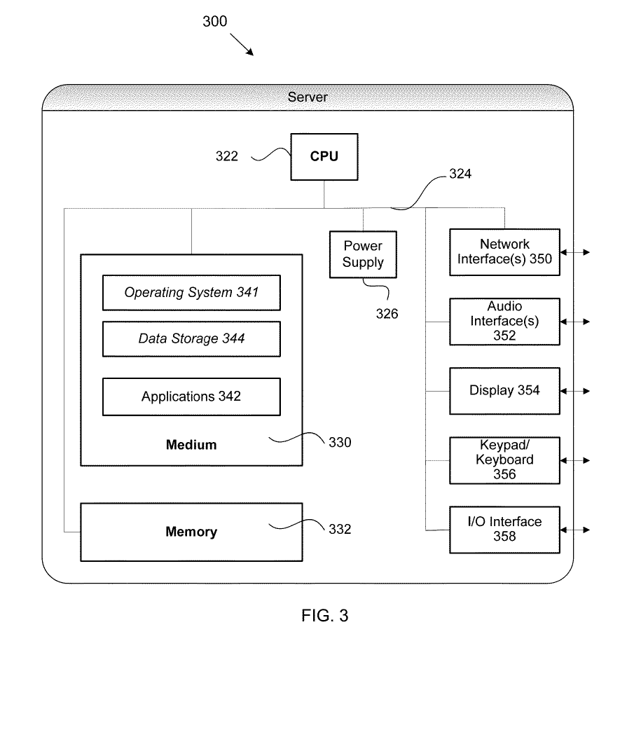

FIG. 3 is a schematic diagram illustrating an example embodiment of a server. A server 300 may include different hardware configurations or capabilities. For example, a server 300 may include one or more central processing units 322, memory 332 that is accessible to the one or more central processing units 322, one or more medium 330 (such as one or more mass storage devices) that store application programs 342 or data 344, one or more power supplies 326, one or more wired or wireless network interfaces 350, one or more input/output interfaces 358. The memory 332 may include non-transitory storage memory and transitory storage memory.

A server 300 may also include one or more operating systems 341, such as Windows Server, Mac OS X, Unix, Linux, FreeBSD, or the like. Thus, a server 300 may include, as examples, dedicated rack-mounted servers, desktop computers, laptop computers, set top boxes, integrated devices combining various features, such as two or more features of the foregoing devices, or the like.

The server 300 in FIG. 3 may serve as any computer server in the computing system 110 shown in FIG. 1. The server 300 may also serve as a computer server that implements the computer system for cold-start and continuous-learning via evolutionary explorations. In either case, the server 300 is in communication with a database that stores serving data and campaign data. The serving data may include serving events, impressions, clicks, and other logged activities related to ad serving. The campaign data may include creative landing uniform resource locator (URL), advertiser name, advertiser product, competitor information, campaign slogan, or other meta-data related to a campaign.

The server 300 combines cold-start and continuous-learning in a unified framework referred to herein as evolutionary exploration. When an ad opportunity such as an ad call is received by the server 300, the server 300 may need to decide whether to bid the ad opportunity for each campaign. As more and more click data are collected, the decisions about which ad opportunities deserve exploration are evolving as the campaign keeps running. The directions of evolution are learned from data and the evolution process is totally data-driven and automated. Further, both semantic similarities and user behaviors are leveraged for exploration and they play different roles with different importance at different stages as the evolution goes on. The unified framework includes two approaches to implement evolutionary exploration. A first approach is evolutionary exploration based on opportunity-campaign similarity. A second approach is evolutionary exploration based on campaign-campaign similarity, which may be combined in a computer system.

In this disclosure, the term ad opportunity is interchangeable with the term bid request. When a user visits a web page on which there is an ad slot associated with a supply-side platform (SSP), an ad opportunity is triggered and the SSP will initialize an auction and broadcast it to connected demand-side platforms (DSPs) and ad exchanges. A DSP typically manages thousands of ad campaigns from different advertisers and decides whether and at what prices to bid on the ad opportunity on behalf of the ad campaigns. The decisions may be made mainly based on the values of the opportunity to the campaigns. For example, if a campaign is a cost-per-mille (CPM) campaign with CPM equal to $10, and with an effective-cost-per-click (eCPC) goal of $2, then the DSP should bid on those ad opportunities whose expected click-through-rate (CTR) is no less than 0.5%. Therefore, one of the most critical components of a DSP is the response prediction model that gives estimation of the response probability below for every (opportunity, campaign) pair.

The response probability may be represented as:
P (respond|opportunity, campaign)

For CPM campaigns with eCPC goals and CPC campaigns, the desired responses are clicks. For campaigns with eCPA goals and CPA campaigns, the desired responses are actions. Referring again to the cold-start and continuous-learning problems to be addressed here, as discussed herein, the mission of both problems is: given a campaign, identify and bid on a subset of all the opportunities that 1) are more probable to have responses than the average, and 2) have not been learned by the prediction model (in other words, the prediction model is not able to give an accurate prediction with confidence).

An ad opportunity in a narrow sense is a unique ad call at a particular timestamp. In a broader sense, an ad opportunity may be described in different granularities. For example, an ad opportunity may be described by the user who triggered it. Then there are possibly multiple identical ad opportunities if they are from the same user. Similarly, an ad opportunity may be described using the page on which it is triggered. Then there are usually multiple identical opportunities from the same page. More broadly, an opportunity may be described by the pair of user and page. The broader description of opportunity using the pair of user and page is used here because it is more generalized and practical. Without loss of generality, the disclosure assumes that opportunities are described as (user, page) pairs and further assumes clicks are the desired responses.

Herein, an ad opportunity, a user, a page, and a campaign are respectively denoted by o, u, p, c. The ad opportunity o=(u, p) is described by a user-page pair. Accordingly, the technical problem of cold-start and continuous-learning may be defined as: given a campaign c, identify a set of opportunities Oₑₓₚₗₒᵣₑ={oᵢ} so that 1) they are more probable to respond than the average, and 2) have not learned by the response prediction model (never or seldom observed before).

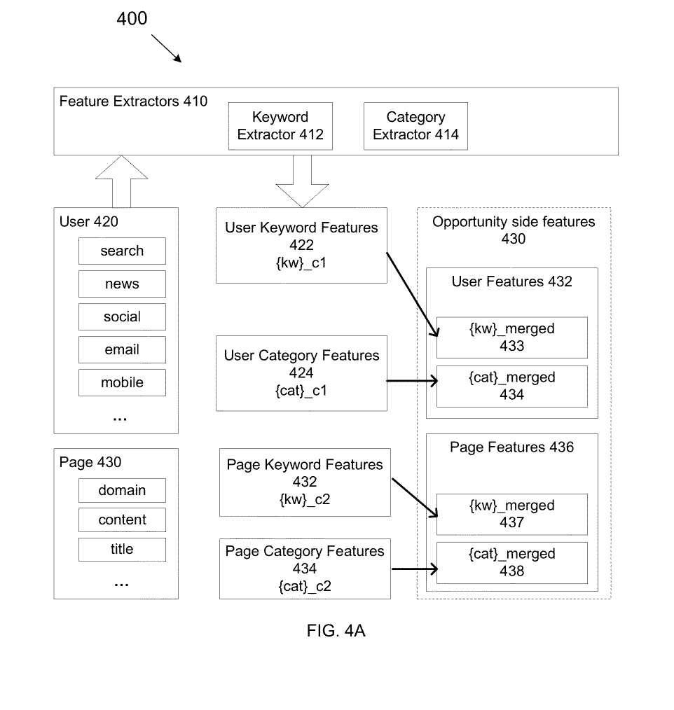

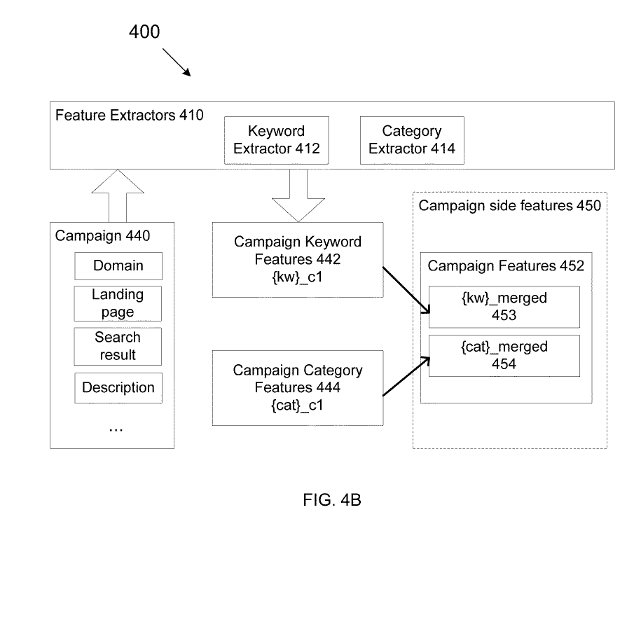

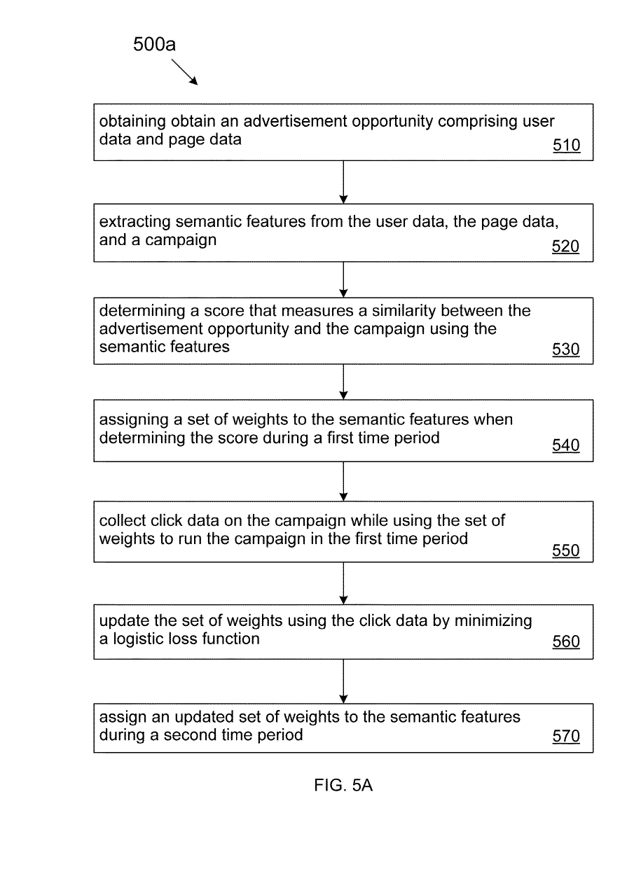

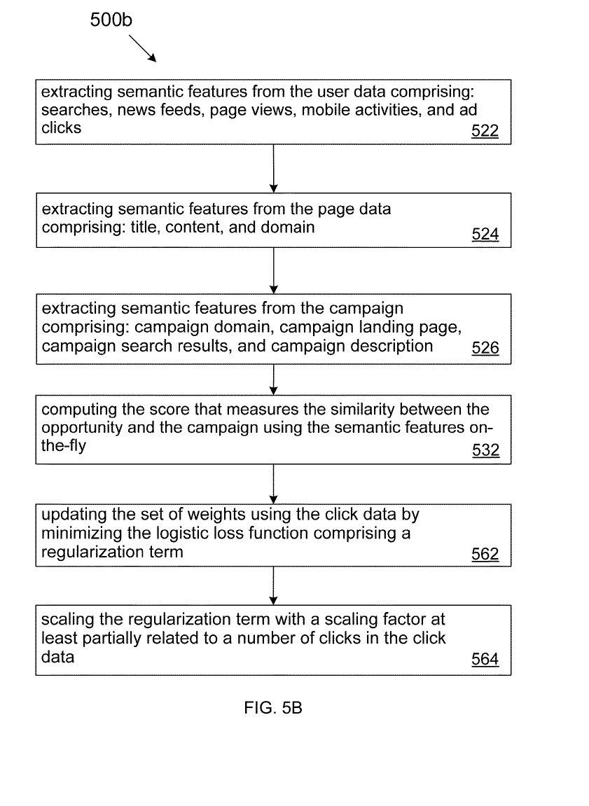

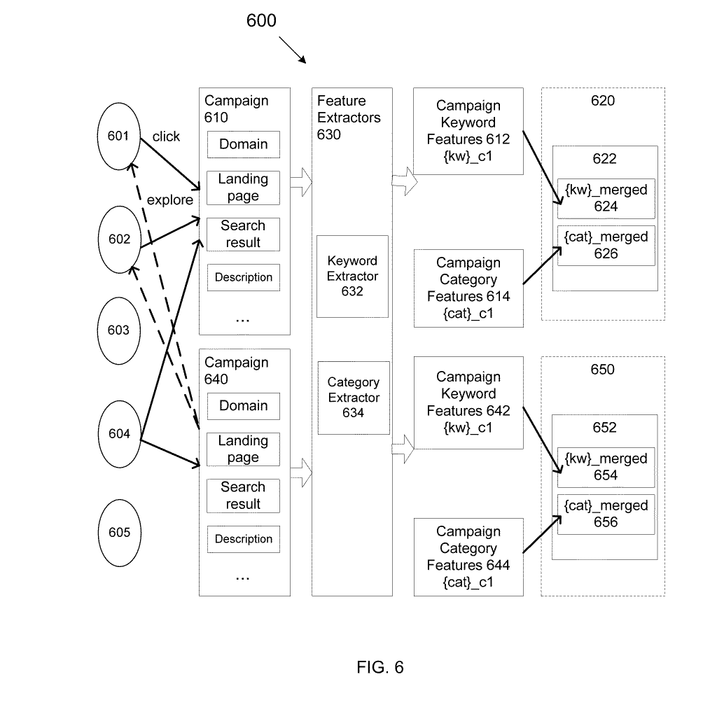

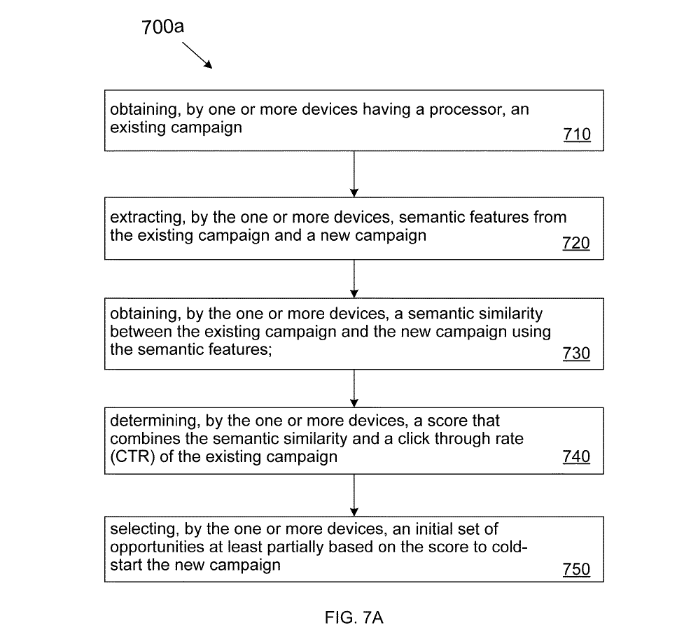

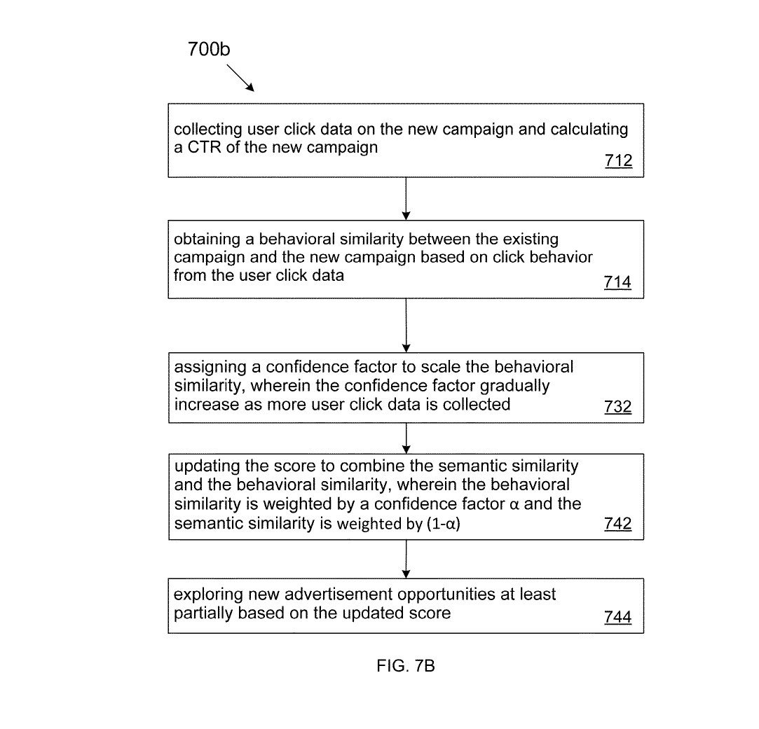

The disclosure provides a computer system that implements a unified framework that includes two approaches to address the above technical problem. The first approach is evolutionary exploration based on opportunity-campaign similarity, which are explained in conjunction with FIGS. 4A-4B and FIGS. 5A-5B below. The second approach is evolutionary exploration based on campaign-campaign similarity, which are explained in conjunction with FIG. 6 and FIGS. 7A-7B below.

FIGS. 4A-4B are example block diagrams illustrating embodiments of the non-transitory storage medium 400 of the server computer 300 illustrated in FIG. 3. The non-transitory storage medium 400 includes one or more modules. The one or more modules may be implemented as program code and data stored on the non-transitory storage medium 400, for example. The non-transitory storage medium 400 may include alternative, additional or fewer modules in other embodiments.

The non-transitory storage medium 400 includes feature extractors 410, which may include a keyword extractor 412 and a category extractor 414. The feature extractors 410 extract semantic features from the user data 420, the page data 421, and a campaign 440. The user data 420 may include searches, news feeds, page views, social data, email data, mobile activities, ad clicks, and etc. The page data 421 may include title, content, domain, and other properties of the webpage. The campaign 440 may include campaign domain, campaign landing page, campaign search results, campaign description, etc.

The feature extractors 410 may be implemented in various ways. For example, the keyword extractor 412 may include Yahoo StoneCutter and the category extractor 414 may include Yahoo content-analysis platform (CAP). Here, Yahoo StoneCutter and Yahoo CAP may be programs implemented in a computer server configured to extract keywords, phrases, or topics from online contents. Features may be from various feature channels. For example, to extract keyword features for a user, the server computer may leverage the user's searches, news articles, social network, emails, and mobile activities, etc. The feature vectors extracted from different channels may then be merged into a single feature vector at each different feature spaces (e.g. keyword, category, or others).

In FIG. 4A, the keyword extractor 412 extracts user keyword features 422 from user data 420. The user keyword features 422 may include a plurality of keyword features from different channels corresponding to the searches, news feeds, page views, social data, email data, mobile activities, ad clicks, etc. in the user data 420. The category extractor 414 extracts user category features 424 from user data 420. The user category features 424 may include a plurality of category features from different channels corresponding to the searches, news feeds, page views, social data, email data, mobile activities, ad clicks, etc. in the user data 420.

Similarly, the keyword extractor 412 extracts page keyword features 432 from page data 430. The page keyword features 432 may include a plurality of keyword features from different channels corresponding to the title, content, domain, and other properties in the page data 421. The category extractor 414 extracts page category features 424 from page data 421. The page category features 434 may include a plurality of category features from different channels corresponding to the title, content, domain, and other properties in the page data 421.

For example, the opportunity side features 430 may include a user feature vector 432 and a page feature vector 436. The user feature vector 432 may include a merged keyword feature 433 and a merged category feature 434. The page feature vector 436 may include a merged keyword feature 437 and a merged category feature 438.

For instance, (f_{u,1}^{kw}, f_{u,2}^{kw}, . . . , f_{u,M}^{kw}) may represent the user keyword feature vector 433 extracted from user u, where M is the cardinality of the keyword space. The merged keyword feature may include M keyword represented as f_{u,i}^{kw}=Σₖ₌₁^{L}^{ᵤ}f_{u,i,channel}_{ₖ}^{kw}, which is the aggregated feature of Lᵤ different channels (search, email, mobile, etc.) of a user. The user category feature vector 434 may be represented as (f_{u,1}^{cat}, f_{u,2}^{cat}, . . . , f_{u,N}^{cat}), which is the category feature vector extracted from user u where N is the cardinality of the category space. Each feature f_{u,j}^{cat}=Σₖ₌₁^{L}^{ᵤ}f_{u,j,channel}_{ₖ}^{cat} is the aggregated feature of Lᵤ different channels (search, email, mobile, etc.) of the user.

Similarly, let (f_{p,1}^{kw}, f_{p,2}^{kw}, . . . , f_{p,M}^{kw}), (f_{p,1}^{cat}, f_{p,2}^{cat}, . . . , f_{p,N}^{cat}) be the feature vectors extracted from page p where f_{p,i}^{kw}=Σₖ₌₁^{L}^{ₚ}f_{p,i,channel}_{ₖ}^{kw}, f_{p,j}^{cat}=Σₖ₌₁^{L}^{ₚ}f_{p,j,channel}_{ₖ}^{cat}.

In FIG. 4B, the feature extractors 410 extract features from campaign 440 and generate campaign keyword features 442 and campaign category features 444. The campaign side features 450 may include campaign features, which may be represented as a campaign feature vector 452. The campaign feature vector 452 may include a merged keyword feature vector 453 and a merged category feature vector 454. For example, the merged keyword feature vector 453 is (f_{c,1}^{kw}, f_{c,2}^{kw}, . . . , f_{c,M}^{kw}) and the merged category feature vector 454 is (f_{c,1}^{cat}, f_{c,2}^{cat}, . . . , f_{c,N}^{cat}), which are the feature vectors extracted from campaign c. Each term in the vectors are merged from different channels: f_{c,i}^{kw}=Σₖ₌₁^{L}^{_{c}}f_{c,i,channel}_{ₖ}^{kw}, f_{c,j}^{cat}=Σₖ₌₁^{L}^{_{c}}f_{c,j,channel}_{ₖ}^{cat}.

A computer server may determine a score that measures a similarity between the advertisement opportunity and the campaign using the semantic features generated by the feature extractors 410. For example, an initial exploration score, score(o, c), may be obtained based on the semantic similarity between opportunity and campaign, In one example,

$$\begin{matrix}score ( o , c ) = score ( ( u , p ) , c ) \\ = sim ( ( u , p ) , c ) \\ = \frac{\begin{matrix}{\sum }_{i = 1}^{M} ( {f}_{u , i}^{kw} + {f}_{p , i}^{kw} ) \times {f}_{c , i}^{kw} + \\ {\sum }_{j = 1}^{N} ( {f}_{u , j}^{cat} + {f}_{p , j}^{cat} ) \times {f}_{c , j}^{cat}\end{matrix}}{\begin{matrix}\sqrt{{\sum }_{i = 1}^{M} {( {f}_{u , i}^{kw} + {f}_{p , i}^{kw} )}^{2} + {\sum }_{j = 1}^{N} {( {f}_{u , j}^{cat} + {f}_{p , j}^{cat} )}^{2}} \times \\ \sqrt{{\sum }_{i = 1}^{M} {f}_{c , i}^{{kw}^{2}} + {\sum }_{j = 1}^{N} {f}_{c , j}^{{cat}^{2}}}\end{matrix}}\end{matrix} \qquad ( 1 )$$

The score in equation (1) is essentially the cosine-similarity between feature vectors (f_{o,1}^{kw}, f_{o,2}^{kw}, . . . , f_{o,M}^{kw}, f_{o,1}^{cat}, f_{o,2}^{cat}, . . . , f_{o,N}^{cat}) and (f_{c,1}^{kw}, f_{c,2}^{kw}, . . . , f_{c,M}^{kw}, f_{c,1}^{cat}, f_{c,2}^{cat}, . . . , f_{c,N}^{cat}), where f_{o,i}^{kw}=f_{u,i}^{kw}+f_{p,i}^{kw}, and f_{o,j}^{cat}=f_{u,j}^{cat}+f_{p,j}^{cat}.

The computer server may use the initial exploration score to determine whether to bid on an ad opportunity during a first time period. The server may select ad opportunities with highest scores for exploration. In practice, there are at least two ways to implement the selection. For example, the server may set a threshold to explore only those opportunities above the threshold. Alternatively or additionally, the server may generate a higher bid on higher score opportunities.

The campaign may start to gain clicks from users when it runs for a while. A computer server may record all the related clicks and/or other actions in a servicing log. Accordingly, the computer server may start to learn from these clicks to direct future explorations. In the initial exploration phase, only semantic similarities are leveraged and the computer server actually has no knowledge about which features play more important roles to achieve successful explorations. For example, the server has no idea whether the user side information from a mobile channel is more important than from an email channel in identifying the source of clicks, whether user side information is more important than page side information, whether keyword features are more important than category features, etc.

Thus, when the computer server has recorded enough clicks related to the campaign, the computer server may learn which channel is more important. The computer server may update the score calculation using the following equation.

$$\begin{matrix}score ( o , c ) = score ( ( u , p ) , c ) \\ = \frac{\begin{matrix}{\sum }_{i = 1}^{M} {a}_{i} \times ( {w}_{user} \times {f}_{u , i}^{kw} + {w}_{page} \times {f}_{p , i}^{kw} ) \times \\ {f}_{c , i}^{kw} + {\sum }_{j = 1}^{N} {b}_{j} \times ( {w}_{user} \times {f}_{u , j}^{cat} + {w}_{page} \times \\ {f}_{p , j}^{cat} ) \times {f}_{c , j}^{cat}\end{matrix}}{\begin{matrix}\sqrt{\begin{matrix}{\sum }_{i = 1}^{M} {a}_{i} \times {( {w}_{user} \times {f}_{u , i}^{kw} + {w}_{page} \times {f}_{p , i}^{kw} )}^{2} + \\ {\sum }_{j = 1}^{N} {b}_{j} \times ( {w}_{user} \times {f}_{u , j}^{cat} + {w}_{page} \times {f}_{p , j}^{cat} )\end{matrix} \times } \\ \sqrt{{\sum }_{i = 1}^{M} {a}_{i} \times {f}_{c , i}^{{kw}^{2}} + {\sum }_{j = 1}^{N} {b}_{j} \times {f}_{c , j}^{{cat}^{2}}}\end{matrix}}\end{matrix} \qquad ( 2 )$$

in which f_{X}_{ᵢ}^{Y}=Σₖ₌₁^{L}^{_{X}}θ_{X,k}^{Y}×f_{X}_{ᵢ}_{channel}_{ₖ}^{Y} (3)

Here, Y may represent a keyword or a category; X may represent user, page, or campaign. The parameter set Θ=(aᵢ, bⱼ, wᵤₛₑᵣ, w_{page}, θ_{X,k}^{Y}) is the set of parameters to learn from click data. The keyword parameters aᵢ may at least partially reflect an importance of the i-th keyword feature. The category parameters bⱼ may at least partially reflect an importance of the j-th category feature. The user parameter wᵤₛₑᵣ and page parameter, w_{page} may at least partially reflect the importance of user side information and page side information, respectively. The channel parameter θ_{X,k}^{Y} may at least partially represent the importance of the k-th channel in feature type Y on X side.

The equation (2) above may be augmented by incorporating non-semantic features from user, page, and/or campaign. For example, user demographic information such as age and gender may be incorporated into equation 2 by adding additional variables and parameters.

One way to derive the values of the above parameters may be solved using an optimization method, in which the learning target is defined as a click. The server may treat opportunities that lead to clicks as positive samples and try to minimize the logistic loss defined as follows:

$$\begin{matrix}J ( Θ ) = {\sum }_{l}^{ } L ( {y}_{l} , score ( {o}_{l} , c , Θ ) ) \\ = {Σ}_{l} log ( 1 + exp ( - {y}_{l} \times score ( {o}_{l} , c ) ) )\end{matrix} \qquad ( 4 )$$

where (oₗ, yₗ) is the l-th sample from data and yₗ∈{±1} indicates whether the sample is positive (a click) or not. There are various ways to solve this optimization problem and derive the values of the parameters. For example, the computer system may use gradient descent method to derive the values of the parameters.

No matter which optimization method is used, at the early stages of an ad campaign, especially when clicks are not sufficient and there are still many opportunities not explored, directly applying knowledge learned from limited number of clicks may be risky. Instead, the exploration strategy should be evolving progressively. In other words, at the beginning when there is small volume of clicks accumulated, the computer system is configured to still rely more on semantic similarity based exploration. As the number of clicks increases, the computer system evolves to rely more on the knowledge learned from clicks. To achieve this goal, suppose the total number of parameters are P, a regularization term may be added into the loss function in equation (4) as follows:

$$\begin{matrix}J ( Θ ) = {\sum }_{l}^{ } L ( {y}_{l} , score ( {o}_{l} , c , Θ ) ) + λ \times R ( Θ ) \\ = {Σ}_{l} log ( 1 + exp ( - {y}_{l} \times score ( {o}_{l} , c ) ) + λ \times {‖ Θ - {( 1 )}_{P} ‖}_{Q}\end{matrix} \qquad ( 5 )$$

where (1)ₚ is a P-dimensional vector whose entries are all 1, Q is the regularization norm (e.g. 1, 2). At the early stages, the computer system may use a large λ to enforce that explorations are based on semantic similarities (Θ=(1)ₚ). As more and more clicks are observed and learned, the computer system may progressively decrease λ and trust more on knowledge (i.e. the parameters) learned from data.

There are many ways to determine the value of λ. Generally speaking, any approach that makes λ monotonically decrease as the number of clicks increases is valid. For example, the computer server may use the following method to determine the value of λ:

$$λ = \begin{matrix}\frac{Min Pos}{\# clicks} & if \# clicks > 0 \\ + ∞ & if \# clicks = 0\end{matrix} \qquad ( 6 )$$

where MinPos is the minimum number of positive samples (clicks) a campaign need to collect to make the scaling factor λ no larger than 1.

In short, in the evolutionary exploration based on opportunity-campaign similarity, all the parameters discussed here are evolving as the number of clicks is increasing. New observed clicks not only contribute to deriving the up-to-date parameters in the scoring function score(o,c), but also determines the level of confidence that the computer system may trust knowledge learned from clicks to guide future explorations. This is also one of the reasons it is called as evolutionary exploration.

FIG. 5A is an example flow diagram 500a illustrating embodiments of the disclosure. The flow diagram 500a may include evolutionary exploration implemented at least partially by a computer system that includes a computer server 300 having a processor or computer and illustrated in FIG. 3. The computer implemented method according to the example flow diagram 500a includes the following acts. Other acts may be added or substituted.

In act 510, the computer system obtains an advertisement opportunity including user data and page data. For example, the computer system may obtain the advertisement opportunity when a user opens a webpage on a user equipment such as a computer, a tablet, or a smartphone. The user data may include searches, news feeds, page views, mobile activities, ad clicks, etc. of the use. The page data may include title, content, and domain of the webpage. The page data may further include information related to the user equipment, operating system, etc.

In act 520, the computer system extracts semantic features from the user data, the page data, and a campaign. As discussed above, the computer system may use feature extractors 410 in FIG. 4A to extract semantic features. The semantic features may include: a user keyword feature vector and a user category feature vector related to the user data; a page keyword feature vector and a page category feature vector related to the page data; and a campaign keyword feature vector and a campaign category feature vector related to the campaign. The computer system may use a sparse matrix to store the extracted feature.

In act 530, the computer system determines a score that measures a similarity between the advertisement opportunity and the campaign using the semantic features. For example, the computer system may use equation (1) or (2) above to calculate the score. During the initial time period, the computer system may use equation (1) to identify the initial set of opportunities.

In act 540, the computer system assigns a set of weights to the semantic features when determining the score during a first time period. The first time period may include the initial time period, which may be defined by a preset threshold of the number of clicks recorded in the campaign. For example, as shown in equation (1) above, the set of weights may be set as constant weights for all terms when the number of clicks is less than N. Here, N may be any integer number such as 1,000, 10,000, or 100,000.

In act 550, the computer system collects click data on the campaign while using the set of weights to run the campaign in the first time period. The computer system may collect click data from different platforms when the total number of clicks is less than a preset threshold. During this period, the computer system may use equation (1) to determine the score.

In act 560, the computer system updates the set of weights using the click data by minimizing a logistic loss function. After the computer system collects enough clicks, the computer system may start update the weighting parameters in parameter set Θ. As the computer system collects more and more clicks, the computer system may update the weighting parameters periodically.

In act 570, the computer system assigns an updated set of weights to the semantic features during a second time period. The computer system may use equation (2) above to determine the weights to the semantic features.

Performance of the above acts is fully automatic and does not need human supervision.

FIG. 5B is an example flow diagram illustrating embodiments of the disclosure.

In act 522, the computer system is programmed to extract semantic features from the user data. For example, extracted features may include searches, news feeds, page views, mobile activities, and ad clicks by a user.

In act 524, the computer server is programmed to extract semantic features from the page data. For example, extracted features may include title, content, and domain of a web page.

In act 526, the computer server is programmed to extract semantic features from the campaign. For example, extracted semantic features may include campaign domain, campaign landing page, campaign search results, and campaign description. In all cases, other additional or alternative features may be extracted from other sources of information.

In act 532, the computer server is programmed to compute the score that measures the similarity between the opportunity and the campaign using the semantic features on-the-fly. For example, the computer system may compute the score using equations (1) or (2) above in real time when the computer system received the opportunity. A user viewing the webpage may not notice any delay time from the computer server because the computation only takes about a few milliseconds for each opportunity.

In act 562, the computer server is programmed to update the set of weights using the click data by minimizing the logistic loss function including a regularization term. For example, the regularization term may be the regularization term (∥Θ−(1)ₚ∥_{Q}) in equation (5).

In act 564, the computer server is programmed to scale the regularization term with a scaling factor at least partially related to a number of clicks in the click data. For example, the regularization term may be scaled using the value of λ in equation (6).

FIG. 6 is an example block diagram 600 illustrating embodiments of the disclosure. FIG. 6 illustrates the second approach of evolutionary exploration based on campaign-campaign similarity.

Campaign 610 and campaign 640 represent two different campaigns. Campaign 610 may be an existing campaign and campaign 640 may be the new campaign. As shown in FIG. 6, there are three clicks collected in campaign 610 from opportunities 601, 602 and 604. The computer server may recommend opportunities 601 and 602 to campaign 640 for further exploration. The feature extractors 630 extract the campaign features from both campaigns 610 and 640. The feature extractors 630 may include a keyword extractor 632 and a category extractor 634. The feature extractors 630 then generate campaign keyword features 612 and campaign category features 614 based on the campaign 610. The features 612 and 614 may be merged to a keyword merged vector 624 and a category merged vector 626. The computer system thus may represent campaign 610 as a campaign vector 620 that includes a plurality of different merged vector 622.

Similarly, the feature extractors 630 also generate campaign keyword features 642 and campaign category features 644 based on the campaign 640. The features 642 and 644 may be merged to a keyword merged vector 654 and a category merged vector 656. The computer system thus may represent campaign 640 as a campaign vector 650 that includes a plurality of different merged vector 652.

Using the extracted feature vectors, the computer system may obtain the campaign-campaign similarity below. When a new campaign starts to run, the computer system has little knowledge which opportunities might be responsive. In the cold-start period, the new campaign may gain help from similar campaigns that are already running. The computer system may quantify the similarity between the new campaign and other existing campaigns that have collected click data. The computer system may recommend those opportunities (i.e. (user, page) pairs) that resulted in clicks on those existing campaigns that are similar with the new campaign.

Initially, the campaign-campaign similarity may only be defined based on their semantics. As the new campaign runs, more and more clicks are observed on the new campaign. The computer system may evolve the similarity between campaigns by incorporating the user behavior data so that the similarity not only considers semantics but also user behaviors. Further explorations are then based on the evolved similarity. Finally, as the clicks continue to accumulate, the new campaign may rely more on user behaviors than semantics to derive the campaign-campaign similarity.

Initially, a new campaign does not have any clicks. The computer system may identify semantically similar campaigns and explore opportunities (i.e. (user, page) pairs) that have clicks on those campaigns. To capture the semantic similarity between campaigns, the same approach as described in the first approach may be used.

First, features may be extracted from each channel of each campaign. Second, the same type of features (e.g. keyword, category) from different channels may be merged to form the feature vectors of a campaign. Finally, campaign-campaign similarity may be derived based on cosine-similarity.

$$\begin{matrix}sim ( {c}_{1} , {c}_{2} ) = semantic\_sim ( {c}_{1} , {c}_{2} ) \\ = \frac{\begin{matrix}{\sum }_{i = 1}^{M} {f}_{{c}_{1} , i}^{kw} \times {f}_{{c}_{2} , i}^{kw} + \\ {\sum }_{j = 1}^{N} {f}_{{c}_{1} , j}^{cat} \times {f}_{{c}_{2} , j}^{cat}\end{matrix}}{\begin{matrix}\sqrt{{\sum }_{i = 1}^{M} {f}_{{c}_{1} , i}^{{kw}^{2}} + {\sum }_{j = 1}^{N} {f}_{{c}_{1} , j}^{{cat}^{2}}} \times \\ \sqrt{{\sum }_{i = 1}^{M} {f}_{{c}_{2} , i}^{{kw}^{2}} + {\sum }_{j = 1}^{N} {f}_{{c}_{2} , j}^{{cat}^{2}}}\end{matrix}}\end{matrix} \qquad ( 7 )$$

where c₁ and c₂ are two campaigns to be compared.

With the campaign-campaign similarity, the initial exploration is based on a score using at least partially the above campaign-campaign similarity in equation (7). For example, the computer system may compute a core using the following equation:

score(o, c)=Σ_{C}_{ᵢ}_{∈C}_{_{existing}} sim(cᵢ,c)×CTR(o, cᵢ) (8)

where CTR(o, cᵢ) is the observed click-through-rate of opportunity o on an existing campaign cᵢ, C_{existing} is the set of existing campaigns with enough click data collected by the computer system. The computer system may explore opportunities with the highest scores. In the initial cold-starting period, the computer system may use a preset threshold to select opportunities having scores greater than the preset threshold.

When more and more clicks are collected as the campaign keeps running, the computer system may evolve the similarity between campaigns by gradually incorporating knowledge learned from these clicks. For example, the computer system may use the following equation with a parameter a to scale the knowledge learned from these clicks.

$$\begin{matrix}sim 1 ( {c}_{1} , {c}_{2} ) = ( 1 - α ) \times semantic\_sim ( {c}_{1} , {c}_{2} ) + α \times behavioral\_sim ( {c}_{1} , {c}_{2} ) \\ where & ( 9 ) \\ behavorial\_sim ( {c}_{1} , {c}_{2} ) = \frac{{Σ}_{k} CTR ( {o}_{k} , {c}_{1} ) \times CTR ( {o}_{k} , {c}_{2} )}{\sqrt{{Σ}_{k} {CTR ( {o}_{k} , {c}_{1} )}^{2}} \times \sqrt{{Σ}_{k} {CTR ( {o}_{k} , {c}_{2} )}^{2}}} & ( 10 )\end{matrix}$$

Here, the behavioral similarity captures the similarity between campaigns based on click behaviors from users. Parameter α∈[0,1] is a confidence factor used to tune how we trust the campaign similarity from behavioral data. Generally, a small value of the confidence factor α is preferred at early stages. As the number of clicks increases, the computer system may gradually increase α to show more confidence on the behavioral data. The computer system may set the value of the confidence factor α using any function that is monotonically increasing as the number of clicks increases. One way to determine the confidence factor α is using the following function in equation (11):

$$α = \frac{2}{π} \times arctan ( \frac{\# clicks}{Min Pos} ) \qquad ( 11 )$$

where MinPos is the minimum number of positive samples (i.e. clicks) a campaign need to collect to make the confidence factor α no less than ½.

The evolving similarity as defined in equation (9) enables evolutionary exploration if the computer system incorporates it into the scoring function as defined in equation (8). Thus, in a second time period, the computer system may use the following equation (12) to determine the score.

score(o,c)=∈_{c}_{ᵢ}_{∈c}_{_{existing}} sim1(cᵢ, c)×CTR(o, cᵢ) (12)

where sim1(cᵢ, c) may be obtained using equations (9), (10), and (11).

Again, the computer system may recommend opportunities with the highest scores to be explored by advertisers. As the campaign similarity evolves, the score of the same opportunity may be quite different from time to time.

FIG. 7A is an example flow diagram 700a illustrating embodiments of the disclosure. The flow diagram 700a may include evolutionary exploration implemented at least partially by a computer system that includes a computer server 300 having a processor or computer and illustrated in FIG. 3. The computer implemented method according to the example flow diagram 700a includes the following acts. Other acts may be added or substituted.

In act 710, the computer system obtains an existing campaign. For example, the computer system may obtain the existing campaign from a databased accessible to the computer system. The database may include servicing logs including: clicks, page views, shopping histories, or other user activities an advertiser may be interested.

In act 720, the computer system extracts semantic features from the existing campaign and a new campaign. The semantic features may include a first campaign keyword feature vector and a first campaign category feature vector related to the existing campaign. The semantic features may further include a second campaign keyword feature vector and a second campaign category feature vector related to the new campaign. As shown in FIG. 6, for example, the computer system may include feature extractors configured to extract keyword and category features from the campaigns. The extracted features may be merged and stored as sparse matrices.

In act 730, the computer system obtains a semantic similarity between the existing campaign and the new campaign using the semantic features. One way to obtain the semantic similarity between the existing campaign and the new campaign is using the equation (7) described above.

In act 740, the computer system determines a score that combines the semantic similarity and a click through rate (CTR) of the existing campaign. Once the semantic similarity is determined, the computer system may determine the score based on the multiplication of the semantic similarity and the CTR of existing campaigns. One example to determine the score is using equation (8) above.

In act 750, the computer system selects an initial set of opportunities at least partially based on the score to cold-start the new campaign. After the computer system determines the score, the computer system may select initial set of opportunities having the highest scores for future exploration. In other words, the computer system may bid the opportunities having the highest scores. The computer system may automatically determine a threshold for each different campaign so that the computer system may bid when the score is greater than or equal to the threshold.

FIG. 7B is an example flow diagram 700b illustrating embodiments of the disclosure. The acts in the example flow diagram 700b may be combined with the acts in the flow diagram 700a shown in FIG. 7A. Similarly, the acts in flow diagram 700b may be implemented at least partially by a computer system that includes a server computer 300 disclosed in FIG. 3. The computer implemented method according to the example flow diagram 700b includes the following acts. Other acts may be added or substituted.

In act 752, the computer system collects user click data on the new campaign and calculates a CTR of the new campaign. When the new campaign started to get attention from users, the computer system may collect user click data related to the new campaign. The computer system may calculate a CTR of the new campaign and monitors the CTR to see if the new campaign is on the right track to reach the performance goal of the advertiser.

In act 754, the computer system obtains a behavioral similarity between the existing campaign and the new campaign based on click behavior from the user click data. The behavioral similarity may be determined using equation (10) above.

In act 756, the computer system assigns a confidence factor to scale the behavioral similarity, where the confidence factor gradually increases as more user click data are collected. The confidence factor may be a function of the number of click collected. The confidence factor may also relate to the CTR of the new campaign. For example, the confidence factor may be determined using equation (11) above.

In act 758, the computer system updates the score to combine the semantic similarity and the behavioral similarity, where the behavioral similarity is weighted by a confidence factor a and the semantic similarity is weighted by (1-α). Generally, the computer system may use two different factors to weight the importance of the semantic similarity and the behavioral similarity. The computer system may need to confine one of the factor gradually increases as more user click data are collected and the other factor gradually decreases simultaneously. Alternatively, the computer system may only need to make one of the factor change while keep the other factor constant. For example, the computer system may use equation (12) to update the score that combines both the semantic similarity and the behavioral similarity.

In act 760, the computer system explores new advertisement opportunities at least partially based on the updated score. When more and more click data are collected in the new campaign, the computer system may use the updated score to determine whether to bed on new advertisement opportunities.

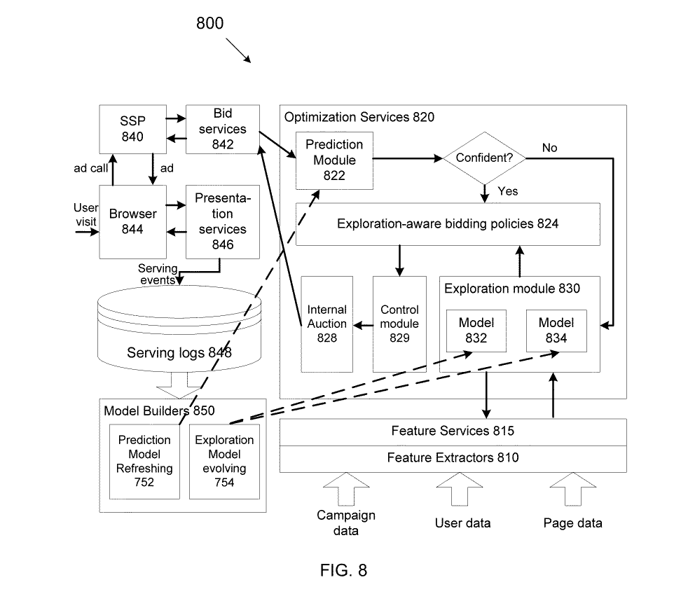

FIG. 8 is an example block diagram illustrating a system architecture 800 of the disclosure. The system architecture 800 supports evolutionary exploration for cold-start and continuously learning disclosed above. The exploration module may be part of a DSP system. Some common modules in a DSP system such as bid services 842, presentation services 846, control module 829, internal auction model 828 etc. are also presented in the architecture 800.

Whenever a user visits a web-page through a browser 844, the browser 844 may trigger an ad call to a SSP 840. The SSP 840 may in turn initialize an auction upon this opportunity and broadcast to connected DSPs. Once the bid services 842 of a DSP receive a bid request, the bid services 842 collects related data and accomplishes some preprocessing work (e.g. filtering based on targeting). Then the bid request is handed over to the optimization services 820 in which the optimizer may determine which campaign to bid on the bid request as well as the bid price. The presentation services 846 may obtain a creative request from the browser 844 and send a creative back to the browser 844. Here, a creative is the actual advertisement viewed by a user. A creative may include brand promoting or messages to convince a user to take some action, like sign up for membership or make a purchase. The presentation services 846 may record all serving events in the serving logs 848 so that the model builders 850 may use the serving events to train different models.

The disclosed system and method provide many substantial advantages and improvements over conventional systems. First, the special computer system includes an exploration module 830 that accepts all the bid requests (ad opportunities) that the response prediction model 822 failed to give a confident prediction. Here, an ad opportunity may be described as a pair of (user, page). The exploration module 830 refers to the feature services 815 in which the features used to compute the scores are pre-generated via feature extractors 810. The features may be extracted from campaign data, user data/events, and page data. The model parameters in model 832 and model 834 of the scoring models are loaded in-memory to score every (user, page, campaign) triplet on-the-fly. For example, the special computer system may use equation (1), (2), (8), and (9) to determine the score of the (user, page, campaign) triplet in real time.

The feature extractors 810 and feature services 815 are similar to the feature extractors described in FIGS. 4A, 4B, and 6. For example, the campaign data may include its domain, landing page, description, etc. The user data/events may include searches, page views, mobile activities, ad clicks, etc. The page data may include title, content, domain, etc. are processed by feature extractors. The resulting features may be store in memory as campaign feature services, user feature services, and page feature services, respectively.

The exploration-aware bidding policies 824 may determine whether and at what price to bid on an opportunity. For example, once an (opportunity, campaign) pair got scored via exploration module, the bidding policies 824 may decide whether and at what price to bid on behalf of the campaign based at least partially on the score. The bidding policies 824 may need to consider a couple of different factors. For instance, the amount of budget allocated for exploration, the threshold score, and, etc. The bidding policies 824 may bid universally with different prices.

The model builders 850 are responsible for building, refreshing, and evolving models using data from serving logs. The model builders 850 may build, update model 832, model 834, and the prediction module 822. The model 832 may implement the evolutionary exploration based on opportunity-campaign similarity as in FIGS. 4A-4B and FIGS. 5A-5B. The model 834 may implement evolutionary exploration based on campaign-campaign similarity as in FIG. 6 and FIGS. 7A-7B.

For example, in the campaign-campaign similarity based evolutionary exploration approach, impression and click data are used to evolve the campaign-campaign similarity as well as the parameter α. The response prediction model 822 may also trained and refreshed in model builders 850.

The disclosed computer implemented method may be stored in computer-readable storage medium. The computer-readable storage medium is accessible to at least one hardware processor. The processor is configured to implement the stored instructions to index audience segments by keywords, so that the audience segments are searchable by keywords.

From the foregoing, it can be seen that the present embodiments provide computer systems and methods for campaign cold-start and continuous-learning in a unified way: evolutionary exploration. The proposed approaches not only exploit the semantic similarities between users and campaigns, pages and campaigns, campaigns and campaigns, but also leverage user behavior data in a progressive manner. The explorations for cold-start and continuous-learning are guided based on the user feedbacks which is a data-driven approach. The system architecture of the proposed systems extend existing efforts within Yahoo towards solutions to cold-start and continuous-learning problems. The proposed systems and methods can significantly improve campaign performance in terms of both delivery and effectiveness (e.g. eCPC, eCPA), increase advertiser satisfaction, and hence boost revenue.

It is therefore intended that the foregoing detailed description be regarded as illustrative rather than limiting, and that it be understood that it is the following claims, including all equivalents, that are intended to define the spirit and scope of this invention.

What is claimed is:

1. A system comprising:
a processor and a non-transitory storage medium accessible to the processor;
a computer server in communication with the non-transitory storage medium, the computer server programmed to:
obtain an advertisement opportunity comprising user data and page data;
extract semantic features from the user data, the page data, and a campaign;
determine a score that measures a similarity between the advertisement opportunity and the campaign using the semantic features;
assign a set of weights to the semantic features when determining the score during a first time period;
collect click data on the campaign while using the set of weights to run the campaign in the first time period;
update the set of weights using the click data by minimizing a logistic loss function; and
assign an updated set of weights to the semantic features during a second time period.

2. The system of claim 1, wherein the semantic features comprise:
a user keyword feature vector and a user category feature vector related to the user data;
a page keyword feature vector and a page category feature vector related to the page data; and
a campaign keyword feature vector and a campaign category feature vector related to the campaign.

3. The system of claim 1, wherein the set of weights comprise:
a keyword parameter that reflects an importance of each keyword feature;
a category parameter that reflects an importance of each category feature;
a user parameter that reflects an importance of the user data;
a page parameter that reflects an importance of the page data; and
a channel parameter that reflects an importance of a data channel.

4. The system of claim 3, wherein the channel parameter, θ_{X,k}^{Y} indicates an importance of a k-th channel in feature type Y on X side, wherein Y indicates a keyword or a category, and wherein X indicates a user, a page, or a campaign.

5. The system of claim 1, wherein the computer server is programmed to compute the score that measures the similarity between the opportunity and the campaign using the semantic features on-the-fly.

6. The system of claim 1,
wherein the computer server is programmed to extract semantic features from the user data comprising: searches, news feeds, page views, mobile activities, and ad clicks; and
wherein the computer server is programmed to extract semantic features from the page data comprising: title, content, and domain.

7. The system of claim 1, wherein the computer server is programmed to extract semantic features from the campaign comprising: campaign domain, campaign landing page, campaign search results, and campaign description.

8. The system of claim 7, wherein the computer server is programmed to update the set of weights using the click data by minimizing the logistic loss function comprising a regularization term, and wherein the computer server is programmed to scale the regularization term with a scaling factor at least partially related to a number of clicks in the click data.

9. A method, comprising:
obtaining, by one or more devices having a processor, an existing campaign;
extracting, by the one or more devices, semantic features from the existing campaign and a new campaign;
obtaining, by the one or more devices, a semantic similarity between the existing campaign and the new campaign using the semantic features;
determining, by the one or more devices, a score that combines the semantic similarity and a click through rate (CTR) of the existing campaign; and
selecting, by the one or more devices, an initial set of opportunities at least partially based on the score to cold-start the new campaign.

10. The method of claim 9, further comprising:
collecting user click data on the new campaign and calculating a CTR of the new campaign.

11. The method of claim 10, further comprising:
obtaining a behavioral similarity between the existing campaign and the new campaign based on click behavior from the user click data.

12. The method of claim 11, further comprising:
assigning a confidence factor to scale the behavioral similarity, wherein the confidence factor gradually increases as more user click data are collected.

13. The method of claim 11, further comprising:
updating the score to combine the semantic similarity and the behavioral similarity, wherein the behavioral similarity is weighted by a confidence factor α and the semantic similarity is weighted by (1-α).

14. The method of claim 13, further comprising:
exploring new advertisement opportunities at least partially based on the updated score.

15. The method of claim 9, wherein the semantic features comprise:
a first campaign keyword feature vector and a first campaign category feature vector related to the existing campaign; and
a second campaign keyword feature vector and a second campaign category feature vector related to the new campaign.

16. A non-transitory storage medium configured to store modules comprising:
module for obtaining obtain an advertisement opportunity comprising user data and page data;
module for extracting semantic features from the user data, the page data, an existing campaign, and a new campaign;
module for determining a first similarity between the advertisement opportunity and the new campaign at least partially based on the semantic features from the user data, the page data, and the new campaign;
module for determining a second similarity between the existing campaign and the new campaign at least partially based on the semantic features from the existing campaign and the new campaign;
module for determining a score that combines the first similarity and the second similarity; and
module for determining whether to select the advertisement opportunity at least partially based on the score.

17. The non-transitory storage medium of claim 16, further comprising:
module for assigning a set of weights to at least one of the semantic features when determining the score during a first time period; and
module for collecting click data on the campaign while using the set of weights to run the campaign in the first time period.

18. The non-transitory storage medium of claim 17, further comprising:
module for updating the set of weights using the click data by minimizing a logistic loss function; and
module for assigning an updated set of weights to the semantic features during a second time period.

19. The non-transitory storage medium of claim 16, further comprising:
module for collecting user click data on the new campaign and calculating a click through rate (CTR) of the new campaign; and
module for obtaining a behavioral similarity between the existing campaign and the new campaign based on click behavior from the user click data.

20. The non-transitory storage medium of claim 19, further comprising:
module for assigning a confidence factor to scale the behavioral similarity, wherein the confidence factor gradually increases as more user click data are collected;
module for updating the score to combine the second similarity and the behavioral similarity, wherein the behavioral similarity is weighted by a confidence factor a and the second similarity is weighted by (1-a); and
module for exploring new advertisement opportunities at least partially based on the updated score.
